(19) United States
(12) Patent Application Publication
(10) Pub. No.: US 2013/0054030 A1
(43) Pub. Date: Feb. 28, 2013

(54) OBJECT GRIPPING APPARATUS, OBJECT GRIPPING METHOD, AND OBJECT GRIPPING PROGRAM

(71) Applicant: Shigeo MURAKAMI, Kyoto-shi (JP)

(72) Inventor: Shigeo MURAKAMI, Kyoto-shi (JP)

(73) Assignee: Dainippon Screen Mfg. Co., Ltd., Kyoto (JP)

(21) Appl. No.: 13/543,682

(22) Filed: Jul. 6, 2012

(30) Foreign Application Priority Data
Aug. 29, 2011 (JP) JP2011-185629

(51) Int. Cl. B25J 9/00; B25J 19/04

(52) U.S. Cl. 700/259; 700/245; 901/31; 901/47; 901/9

(57) ABSTRACT

In an object gripping apparatus according to the present invention, based on three-dimensional position and attitude of a gripping object and a gripping position that is preliminarily set for each gripping object, an operation of a grip part is controlled such that the grip part grips the gripping position on the gripping object. Thereby, an intended gripping position can be identified, and the object can be appropriately gripped.

### BACKGROUND OF THE INVENTION

1. Field of the Invention

The present invention relates to an object gripping apparatus, an object gripping method, and an object gripping program, and particularly to a control of an operation of a hand part provided in a robot.

2. Description of the Background Art

Conventionally implemented is a method in which an object is three-dimensionally recognized and thus a hand part of a robot is handled with a recognized three-dimensional position of the object being set as a target.

Japanese Patent Application Laid-Open No. 2006-350620 discloses a method for performing an assembling operation by a robot using three-dimensional CAD (Computer Aided Design) data. To be specific, the assembling operation is performed by teaching. A position to be gripped by a hand part of a robot is set at a time of assembling.

Japanese Patent Application Laid-Open No. 2008-46924 discloses a method for improving the operability by preparing a sequence of assembling operations.

In the method shown in Japanese Patent Application Laid-Open No. 2006-350620, in order that the object can actually be, for example, gripped by the hand part, it is necessary to simulate the degree of adaptation of the shape of the hand part to the shape of a recognition object, and the like, and perform handling of the hand part.

Here, in some cases, the positional relationship of the hand part relative to the recognition object identified in this simulation, such as a position on the recognition object to be gripped by the hand part, is different from the one originally intended at a time when a component part or the like serving as the recognition object was designed. Thus, there is a problem that a position on the component part, or the like, intended to be gripped at a time of designing is sometimes different from a gripping position identified by the simulation, which results in failure to appropriately perform the operation.

Moreover, in a case of combining component parts, or the like, serving as the recognition objects to manufacture a product, a gripping position intended to be effective in the combining can sometimes not be identified by simulation, which may results in failure to achieve an intended assembling state.

### SUMMARY OF THE INVENTION

The present invention is directed to an object gripping apparatus for a control of an operation of a hand part provided in a robot.

In an aspect of the present invention, an object gripping apparatus includes a grip part for gripping a gripping object, and a control part for controlling an operation of the grip part. Based on three-dimensional position and attitude of the gripping object and a gripping position that is preliminarily set for each of the gripping objects, the control part controls the operation of the grip part so as to grip the gripping position on the gripping object.

By controlling the operation of the grip part so as to grip the gripping position that is preliminarily set on the gripping object, an intended gripping position can be identified and the gripping object can be appropriately gripped.

Preferably, one or a plurality of the gripping positions are set for each of the gripping objects.

Gripping position information includes information of the angle of approach, and one or a plurality of gripping positions are set for each of the gripping objects and selected in accordance with a three-dimensional attitude. Thereby, a suitable gripping position can be selected depending on a state of the grip part and the gripping object.

Preferably, in a case where a plurality of the gripping objects are combined with each other, the gripping position is preliminarily set so as to keep away from a contact portion at which the gripping objects are brought into contact with each other.

The gripping position information that is preliminarily set such that the gripping position keeps away from the contact portion includes the information of the angle of approach of the grip part, and the angle of approach is such an angle of approach that the grip part does not cover the contact portion. Thereby, the three-dimensional position and attitude of the grip part at a time of performing a combining operation can be controlled. Thus, when combining the gripping objects with each other, the combining operation can be appropriately performed without being obstructed by the grip part.

The present invention is also directed to an object gripping method regarding a control of an operation of a hand part provided in a robot.

In an aspect of the present invention, an object gripping method includes the steps of: (a) obtaining information of three-dimensional position and attitude of a gripping object; (b) obtaining gripping position information that is preliminarily set for each of the gripping objects; and (c) based on the three-dimensional position and attitude of the gripping object and a gripping position on the gripping object, controlling an operation of the grip part so as to grip the gripping position.

By controlling the operation of the grip part so as to grip the gripping position that is preliminarily set on the gripping object, the intended gripping position can be identified, and the gripping object can be appropriately gripped.

The present invention is also directed to an object gripping program regarding a control of an operation of a hand part provided in a robot.

Therefore, an object of the present invention is to identify an intended gripping position and appropriately grip an object.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram conceptually showing a configuration of an object gripping apparatus according to a first preferred embodiment;

FIG. 2 is a diagram showing an example of a hardware structure of the object gripping apparatus according to the first preferred embodiment;

FIG. 3 is a flowchart showing an operation of the object gripping apparatus according to the first preferred embodiment;

FIGS. 4A to 4C are diagrams for explaining the operation of the object gripping apparatus according to the first preferred embodiment;

FIG. 5 is a diagram conceptually showing a configuration of an object gripping apparatus according to a second preferred embodiment;

FIG. 6 is a diagram showing an example of a hardware structure of the object gripping apparatus according to the second preferred embodiment;

FIG. 7 is a flowchart showing an operation of the object gripping apparatus according to the second preferred embodiment; and

FIGS. 8A and 8B are diagrams for explaining the operation of the object gripping apparatus according to the second preferred embodiment.

### DESCRIPTION OF THE PREFERRED EMBODIMENTS

### A. First Preferred Embodiment

### A-1. Configuration

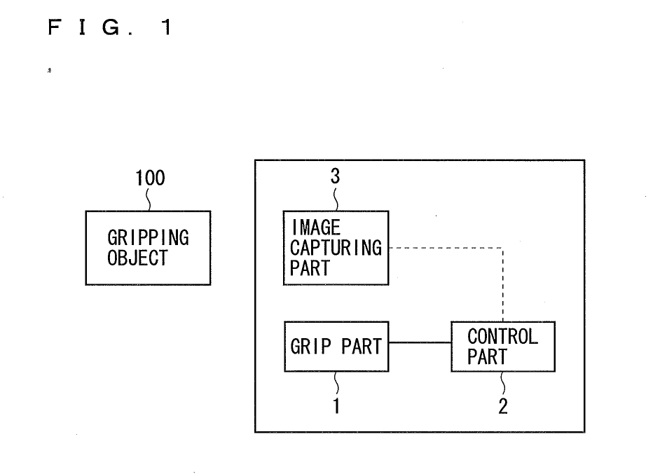

FIG. 1 is a diagram conceptually showing a configuration of an object gripping apparatus according to this preferred embodiment. As shown in FIG. 1, an object gripping apparatus according to the present invention includes a grip part 1 (for example, a hand part of a robot) for gripping a gripping object 100, and a control part 2 for controlling an operation of the grip part 1.

Moreover, as shown in FIG. 1, to recognize the three-dimensional position and attitude of the gripping object 100, an image capturing part 3 may also be provided.

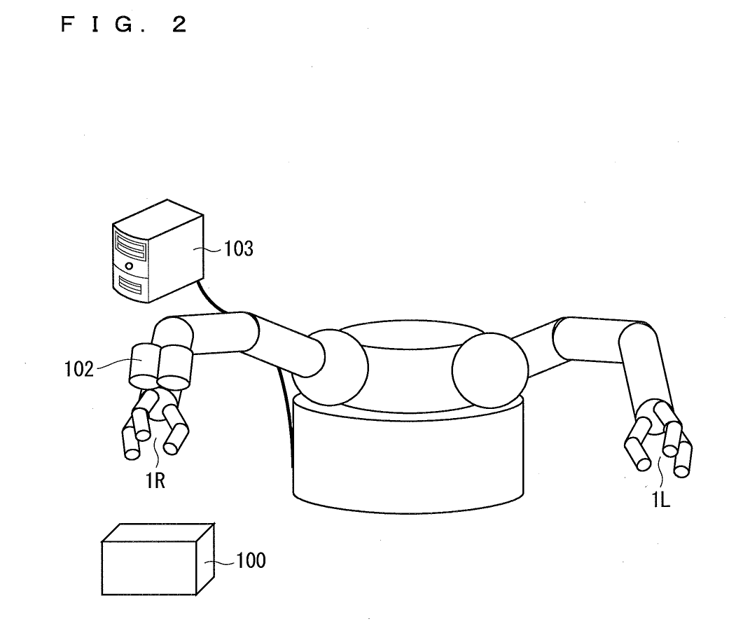

For example, in a case where the image capturing part 3 such as a stereo camera is provided, a disparity image of the gripping object 100 captured by the image capturing part 3 is used for matching against a three-dimensional model of the gripping object 100 that is preliminarily prepared. Thereby, the three-dimensional position and attitude of the gripping object 100 can be obtained. It is possible that the image capturing part 3 is mounted to the grip part 1. More specifically, in a case where the grip part 1 is a hand part of a robot, the grip part 1 being mounted to a base portion (see FIG. 2) of the hand part can capture the gripping object 100 from a point of view that is closer to the gripping object 100. This enables the three-dimensional position and attitude to be recognized with an enhanced accuracy.

Even in a case where the image capturing part 3 is not provided, it suffices that the three-dimensional position and the attitude of the gripping object 100 can be measured by a sensor or the like, and a result of the measurement may be supplied from the outside to the control part 2.

FIG. 2 shows an example of a hardware structure of the object gripping apparatus according to this preferred embodiment.

As shown in FIG. 2, the object gripping apparatus includes the grip part 1 (corresponding to a hand part 1R and a hand part 1L of the robot) for gripping the gripping object 100 (for example, a component part or the like), the image capturing part 3 (corresponding to a camera 102 mounted to the hand part) for recognizing the three-dimensional position and attitude of the gripping object 100, and the control part 2 (corresponding to a CPU 103) for controlling the operation of the grip part 1.

Although FIG. 2 shows a robot with two arms as the object gripping apparatus, the object gripping apparatus may be a robot with a single arm. The shape of the gripping object 100 is not limited to the illustrated one.

### A-2. Operation

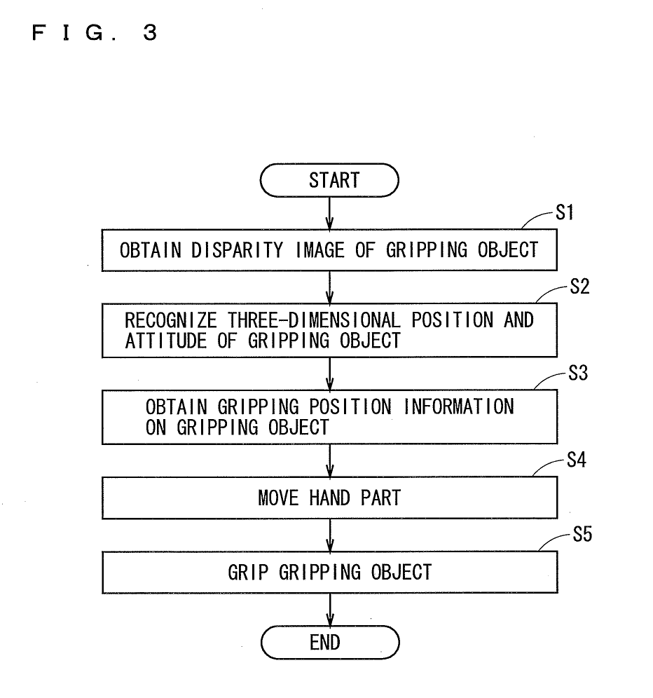

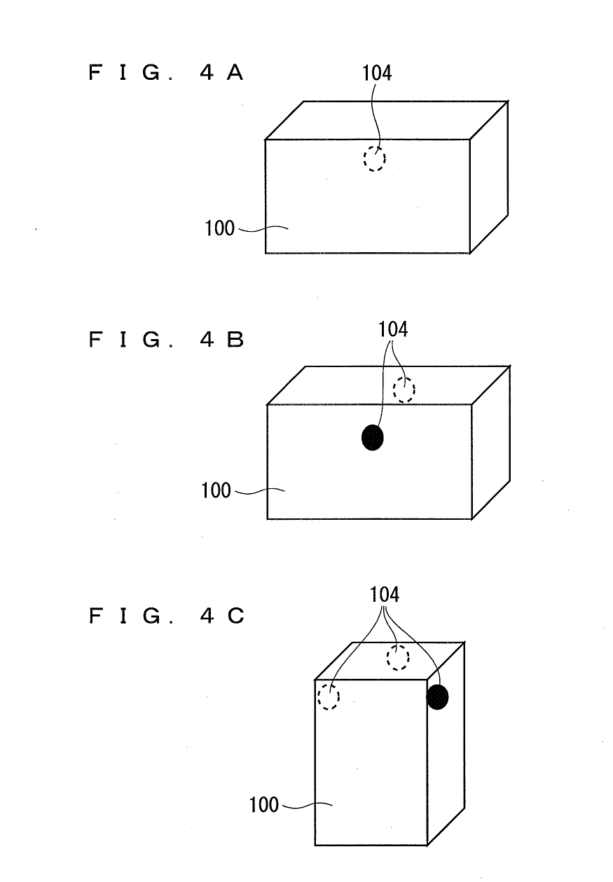

Next, an operation of the object gripping apparatus according to this preferred embodiment performed by the control part 2 will be described with reference to FIGS. 3 and 4A to 4C.

Firstly, a disparity image of the gripping object 100 is obtained by using the camera 102 (step S1). Here, in a case where the three-dimensional position and attitude of the gripping object 100 are recognized without using image matching, this operation can be omitted.

Then, three-dimensional matching is performed by using the disparity image and a three-dimensional model that is preliminarily prepared or measured with respect to the gripping object 100 (step S2). Here, the three-dimensional model indicates an aggregation of point groups each having three-dimensional coordinate information, and is made up of three-dimensional coordinate information corresponding to each side, each vertex, and the like, of the gripping object 100. The three-dimensional model is stored in a predetermined storage part or the like, and read out and used at a time of performing the three-dimensional matching. By the three-dimensional matching, the three-dimensional position and attitude of the gripping object 100 can be recognized.

Then, gripping position information about a gripping position on the gripping object 100 that is preliminarily set is obtained (step S3), and a gripping position in the three-dimensional position and attitude of the gripping object 100 is identified.

This gripping position information is, for example, set as shown in FIGS. 4A to 4C, and is information that pre-identifies a position to be gripped by the hand part 1R with respect to each gripping object 100. More specifically, the gripping position information is, for example, text data of the three-dimensional coordinate information indicating a gripping position 104, which is described in a local coordinate system that is fixed for each gripping object 100. For controlling an operation of the hand part 1R, the gripping position information is used after the local coordinate system is converted into a coordinate system of the robot.

It may be acceptable to set a plurality of the gripping positions 104, depending on a state (the shape and size of the hand part, the number of fingers, the position of the center of gravity, and the like) of the hand part 1R, the strength of a portion of the gripping object 100 to be gripped by the hand part 1R, and the like. For example, as shown in FIGS. 4A and 4B, in a case where the three-dimensional attitude of the gripping object 100 is the same, a suitable gripping position 104 can be selected in accordance with the state of the hand part 1R. To be specific, a suitable gripping position 104 can be selected in consideration of a range where the fingers operate, a gripping force of the fingers exerted at a time of gripping, a position interval and a gripping force tolerance of the gripping position against them, and the like. This selection may be made at the current time, or may be made after the hand part 1R is moved to the vicinity of the three-dimensional position of the gripping object 100.

In a case shown in FIG. 4A, a gripping operation of the hand part 1R is controlled such that the gripping position 104 corresponds to the center of the three-dimensional position of the hand part 1R. In a case shown in FIG. 4B, the gripping operation of the hand part 1R is controlled such that the gripping position 104 corresponds to the position of each finger of the hand part 1R. It is also possible to provide three or more gripping positions 104 in accordance with the number of fingers, as shown in FIG. 4C.

The gripping position information may include not only the information about the position to be gripped but also angle information about the angle of approach of the hand part 1R to the gripping position 104. The angle information is data of an angle (direction) described in a local coordinate system that is fixed for each gripping object 100. For controlling the operation of the hand part 1R, the angle information is used after the local coordinate system is converted into a coordinate system of the robot. By the angle information, the three-dimensional position and attitude of the hand part 1R at a time when the hand part 1R performs the gripping operation can also be controlled.

As the gripping position 104 set in the gripping object 100, a plurality of positions may be set corresponding to a three-dimensional attitude in which the gripping object 100 is placed. By setting in this manner, for the gripping object 100 having different three-dimensional attitudes, at least one appropriate gripping position 104 can be selected for use in the gripping operation. To be specific, a gripping position that causes as small as possible a change in the three-dimensional attitude of the gripping object 100 (for example, surfaces and sides except the surface located vertically downward in a state where the gripping object 100 is placed) can be selected, or instead, a gripping position that can change the three-dimensional attitude into a desired three-dimensional attitude can be selected. This selection may be made at the current time, or may be made after the hand part 1R is moved to the vicinity of the three-dimensional position of the gripping object 100.

It is desirable that the gripping position information is preliminarily attached to the three-dimensional model of the gripping object 100. However, the gripping position information may be preliminarily stored in another storage part or the like, and may be supplied to the control part 2 at a time of the gripping operation. In a case where the gripping position information is preliminarily attached to the three-dimensional model, it is desirable that the gripping position information is attached to three-dimensional CAD data of each gripping object 100 at a stage of preparation of the three-dimensional model. If the gripping position information has been attached in this manner, a position suitable for gripping that has been assumed with respect to each gripping object at a time of designing can be identified when the gripping operation is performed. Thus, the intended gripping operation can be achieved with an enhanced probability.

Then, the control part 2 moves the hand part 1R based on the three-dimensional position and attitude as well as the gripping position 104 on the gripping object 100 (step S4), and causes the hand part 1R to grip the gripping position 104 on the gripping object 100 (step S5).

At a time of gripping, the gripping operation can be performed while whether or not the gripping position 104 indicated by the gripping position information is being appropriately gripped is checked using the camera 102 provided to the hand part 1R. In a case where the number of gripping positions to be gripped by the hand part 1R is one, it is preferable to perform the gripping operation with the one position being set at the center of an image capturing region of the camera 102 (in this case, the gripping position is set so as to correspond to the center of the three-dimensional position of the grip part 1). In a case where the number of gripping positions to be gripped by the hand part 1R is two, it is preferable to perform the gripping operation with the central position between the two positions being set at the center of the image capturing region of the camera 102.

### A-3. Effects

In the preferred embodiment according to the present invention, in the object gripping apparatus, the operation of the grip part 1 is controlled so as to grip the gripping position 104 on the gripping object 100, based on the three-dimensional position and attitude of the gripping object 100 and the gripping position 104 that is preliminarily set for each gripping object 100, to thereby identify the intended gripping position 104 and appropriately grip the gripping object 100.

Additionally, it is not necessary to simulate the shape of the gripping object 100 and the shape of the hand part 1R for confirming the positional relationship therebetween. Thus, the operation can be easily controlled.

In the preferred embodiment according to the present invention, in the object gripping apparatus, the information of the gripping position 104 is attached to the three-dimensional model of the gripping object 100. Therefore, the position to be gripped that has been assumed for each gripping object at a time of designing can be preliminarily set, and thus the operation can be performed while an intended portion is gripped.

In the preferred embodiment according to the present invention, in the object gripping apparatus, one or a plurality of gripping positions 104 are set for each gripping object 100. Therefore, an appropriate gripping position 104 can be selected in accordance with a state of the hand part 1R.

In the preferred embodiment according to the present invention, in the object gripping apparatus, the control part 2 selects at least one of the plurality of gripping positions 104 that have been set, in accordance with the three-dimensional attitude of the gripping object 100. Thereby, a suitable gripping position can be selected depending on a state of the gripping object 100.

In the preferred embodiment according to the present invention, in the object gripping apparatus, the information of the gripping position 104 includes information of the angle of approach of the grip part 1 to the gripping position 104. Thereby, the three-dimensional position and attitude of the hand part 1R at a time of performing the gripping operation can be controlled. Thus, a gripping operation better suited to the intention can be achieved.

### B. Second Preferred Embodiment

### B-1. Configuration

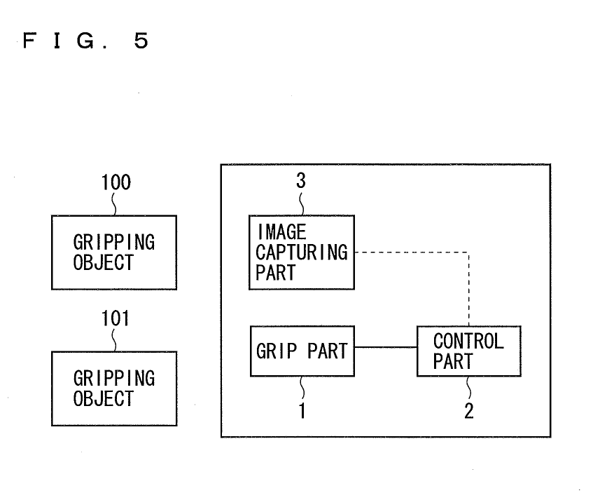

FIG. 5 is a diagram conceptually showing a configuration of an object gripping apparatus according to this preferred embodiment. As shown in FIG. 5, similarly to the first preferred embodiment, the object gripping apparatus includes the grip part 1, the control part 2, and the image capturing part 3, but the object gripping apparatus of this preferred embodiment is different from that of the first preferred embodiment in terms of gripping a plurality of gripping objects 100 and 101. Although FIG. 5 shows two gripping objects, the number of gripping objects is not limited to two, and may be any number equal to or more than two.

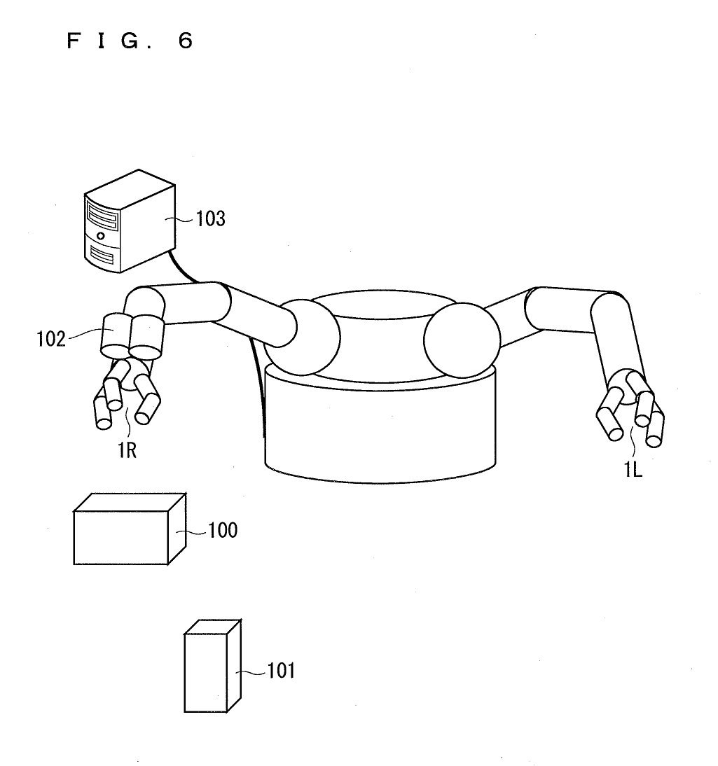

FIG. 6 shows an example of a hardware structure of the object gripping apparatus according to this preferred embodiment.

As shown in FIG. 6, the object gripping apparatus includes the grip part 1 (corresponding to the hand part 1R and the hand part 1L of the robot) for gripping the gripping object 100 (for example, a component part or the like) and a gripping object 101 (for example, a component part or the like), the image capturing part 3 (corresponding to the camera 102 mounted to the hand part) for recognizing three-dimensional positions and attitudes of the gripping object 100 and the gripping object 101, and the control part 2 (corresponding to the CPU 103) for controlling the operation of the grip part 1. Here, the gripping object 100 and the gripping object 101 are component parts, or the like, that are adapted to be combined with each other.

The object gripping apparatus shown in FIG. 6 can grip at least one of the gripping object 100 and the gripping object 101, and combine it with the other gripping object, to perform an operation.

### B-2. Operation

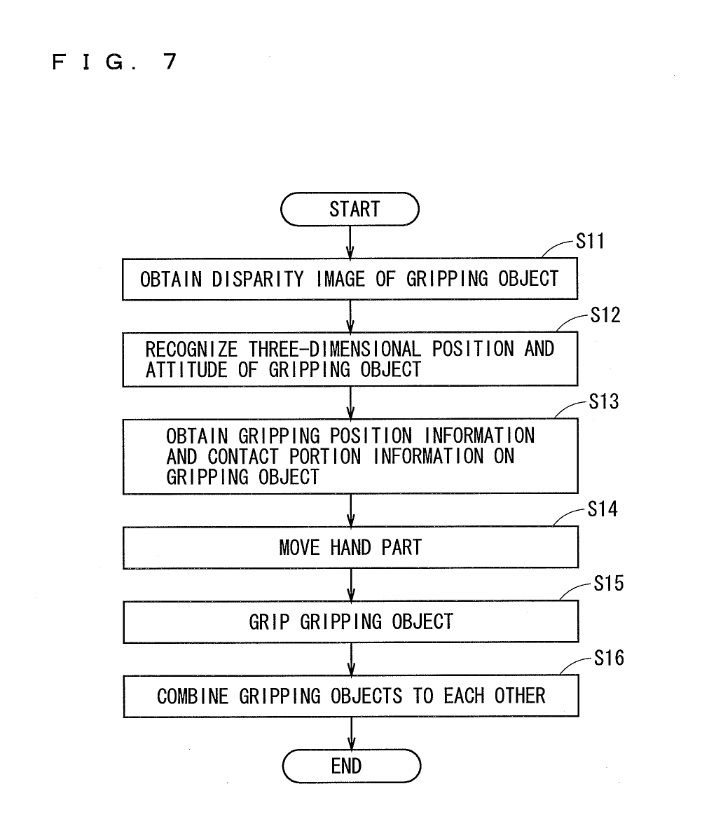

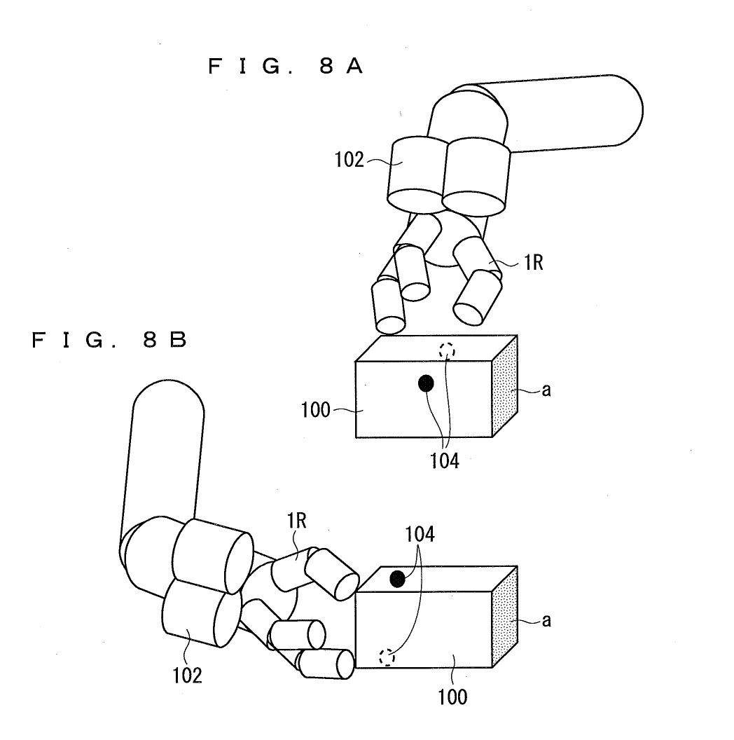

Next, an operation of the object gripping apparatus according to this preferred embodiment performed by the control part 2 will be described with reference to FIGS. 7 and 8.

Firstly, a disparity image of the gripping object 100 is obtained by using the camera 102 (step S11). Then, three-dimensional matching is performed by using the disparity image and a three-dimensional model that has been preliminarily measured for the gripping object 100 (step S12). By the three-dimensional matching, the three-dimensional position and attitude of the gripping object 100 can be recognized.

Then, the gripping position information that is preliminarily set on the gripping object 100 and contact portion information which will be described later are obtained (step S13), and a gripping position in the three-dimensional position and attitude of the gripping object 100 is identified.

Here, based on the contact portion information that is information about a surface and a side that will be brought into contact when the combining is made, that is, information about a contact portion a, the gripping position is set so as to keep away from the contact portion a, as shown in FIGS. 8A and 8B. Additionally, the information about the angle of approach of the hand part 1R to the gripping position 104, which is included in the gripping position information, can be set such that the gripping position 104 is gripped with an angle of approach that prevents the hand part 1R from covering the contact portion a.

Similarly to the gripping position information, the contact portion information thus obtained is desirably attached to the three-dimensional models of the gripping object 100 and the gripping object 101. However, the contact portion information may be preliminarily stored in another storage part or the like, and may be supplied to the control part 2 at a time of the gripping operation. In a case where the contact portion information is preliminarily attached to the three-dimensional model, it is desirable that the contact portion information is attached to the three-dimensional CAD data of each gripping object at a stage of preparation of the three-dimensional model and associated with a bill of materials (BOM).

It may be acceptable that, in the contact portion information, a plurality of patterns are set corresponding to how each gripping object is combined. Although FIG. 8 shows a plurality of gripping positions 104 that are set with respect to the common contact portion a, a new gripping position 104 can be preliminarily set if another contact portion a is set.

Then, the control part 2 moves the hand part 1R based on the three-dimensional position and attitude as well as the gripping position, and the like, of the gripping object 100 (step S14), and causes the hand part 1R to grip the gripping position on the gripping object 100 (step S15). Here, an object to be gripped may be the gripping object 101. In this case, the above-described operations are performed on the gripping object 101.

Then, the three-dimensional position and attitude of the gripping object 100 (or the gripping object 101) are set such that the contact portion of the gripping object 100 (or the gripping object 101) is brought into contact with a contact portion of the other gripping object 101 (or the gripping object 100), and the gripping object 101 and the gripping object 100 are combined with each other (step S16).

### B-3. Effects

In the preferred embodiment according to the present invention, in the object gripping apparatus, the gripping position 104 is preliminarily set so as to keep away from the contact portion a at which the gripping object 100 and the gripping object 101 are brought into contact with each other. This can prevent the hand part 1R from obstructing the operation of combining the gripping objects with each other, and thus the combining operation can be appropriately performed.

In the preferred embodiment according to the present invention, in the object gripping apparatus, the information of the gripping position 104 includes the information of the angle of approach of the grip part 1 to the gripping position 104, and the angle of approach is such an angle of approach that the grip part 1 does not cover the contact portion a. Thereby, the three-dimensional position and attitude of the hand part 1R at a time of performing the combining operation can be controlled. Thus, the operation of the hand part 1R can be controlled without obstructing the combining operation.

Moreover, the gripping position can be easily identified not based on teaching. This makes it easy to prepare a program that requires a complicated assembling process, such as involving a large number of component parts.

The present invention can be used for an assembling operation for assembling component parts or devices using a robot.

While the invention has been shown and described in detail, the foregoing description is in all aspects illustrative and not restrictive. It is therefore understood that numerous modifications and variations can be devised without departing from the scope of the invention.

What is claimed is:

1. An object gripping apparatus comprising:
a grip part for gripping a gripping object; and
a control part for controlling an operation of said grip part, wherein
based on a three-dimensional position and attitude of said gripping object and a gripping position that is preliminarily set for each of said gripping objects, said control part controls the operation of said grip part so as to grip said gripping position on said gripping object.

2. The object gripping apparatus according to claim 1, further comprising
an image capturing part for capturing a disparity image of said gripping object, wherein
information of said three-dimensional position and attitude of said gripping object is generated based on said disparity image captured by said image capturing part.

3. The object gripping apparatus according to claim 2, wherein
said information of said three-dimensional position and attitude of said gripping object is generated by matching a three-dimensional model that is preliminarily prepared for each of said gripping objects against said disparity image captured by said image capturing part.

4. The object gripping apparatus according to claim 3, wherein
said gripping position information is attached to said three-dimensional model.

5. The object gripping apparatus according to claim 2, wherein
said image capturing part is mounted to said grip part.

6. The object gripping apparatus according to claim 1, wherein
one or a plurality of said gripping positions are set for each of said gripping objects.

7. The object gripping apparatus according to claim 6, wherein
said control part selects at least one of a plurality of said gripping positions being set, in accordance with said three-dimensional attitude of said gripping object.

8. The object gripping apparatus according to claim 1, wherein
said gripping position information includes information of the angle of approach of said grip part to said gripping position.

9. The object gripping apparatus according to claim 1, wherein
in a case where a plurality of said gripping objects are combined with each other, said gripping position is preliminarily set so as to keep away from a contact portion at which said gripping objects are brought into contact with each other.

10. The object gripping apparatus according to claim 9, wherein
said gripping position information includes information of the angle of approach of said grip part to said gripping position,
said angle of approach is such an angle of approach that the three-dimensional position of said grip part is a three-dimensional position that does not cover said contact portion.

11. An object gripping method for controlling a predetermined grip part provided with a grip mechanism by means of a predetermined control part, to thereby cause said grip part to grip a gripping object, said method comprising the steps of:
(a) obtaining information of a three-dimensional position and attitude of said gripping object;
(b) obtaining gripping position information that is preliminarily set for each of said gripping objects; and
(c) based on the three-dimensional position and attitude of said gripping object and a gripping position on said gripping object, controlling, by said control part, an operation of said grip part so as to grip said gripping position.

12. An object gripping program installed in a computer and, when executed, causing an apparatus for controlling said grip part by means of said computer to function as the object gripping apparatus according to claim 1.
